(19) United States
(12) Patent Application Publication
(10) Pub. No.: US 2026/0241763 A1
(43) Pub. Date: Aug. 20, 2026

(54) STABILIZER BAR ASSEMBLY

(71) Applicant: HYUNDAI MOBIS CO., LTD., Seoul (KR)

(72) Inventor: Sang Mu LEE, Yongin-si (KR)

(73) Assignee: HYUNDAI MOBIS CO., LTD., Seoul (KR)

(21) Appl. No.: 19/386,870

(22) Filed: Nov. 12, 2025

(30) Foreign Application Priority Data
Feb. 17, 2025 (KR) 10-2025-0020180

(51) Int. Cl. B60G 17/015; B60G 21/02

(52) U.S. Cl. CPC B60G 17/0157; B60G 21/026; B60G 2202/135; B60G 2202/42; B60G 2206/427; B60G 2800/012

(57) ABSTRACT

A stabilizer bar assembly includes a movable member including one or more guide protrusions protruding outward, a housing including a movable member receptacle where the movable member is disposed and a drive member receptacle where a drive member which moves the movable member is disposed, the drive member receptacle being connected to the movable member receptacle, a first stabilizer bar connected to a first side of the housing to selectively rotate and allowing the movable member to be inserted thereinto, and a second stabilizer bar connected to a second side of the housing to rotate integrally with the housing.

### CROSS-REFERENCE TO RELATED APPLICATION

This application claims priority from and the benefit of Korean Patent Application No. 10-2025-0020180, filed on February 17, 2025, which is hereby incorporated by reference for all purposes as if set forth herein.

### BACKGROUND

### Field

The disclosure relates to a stabilizer bar assembly and, more particularly, to a stabilizer bar assembly configured to separate two wheels of a vehicle depending on road conditions.

### Description of the Related Art

Generally, roll phenomena occurring when a vehicle turns are factors that impair vehicle stability and, in severe cases, may lead to rollover accidents. To prevent such roll phenomena in vehicles, a stabilizer bar may be used to reduce roll phenomena by applying rigidity to the vehicle body when there is a height difference between the left and right sides of the vehicle.

However, conventional stabilizer bars maintain constant torsional rigidity under all driving conditions, which may reduce ride comfort under particular conditions.

For example, when the rigidity of the stabilizer bar remains constant during off-road driving or on bumpy roads, the vehicle wheels may have restricted independent movement, which may reduce ride comfort and impair driving performance.

To solve this problem, a structure which separates the connection between two wheels of the vehicle depending on road conditions while maintaining the stabilizer bar is required. A solenoid valve may be used as the stabilizer bar separation structure, but the problem is that complex hydraulic control stabilizer bars and increased number of parts. The background technology of the disclosure is disclosed in Korean Patent No. 10-1998-0035579 (published on August 5, 1998 and entitled “Stabilizer Bar Control Device”).

### SUMMARY

The disclosure is devised to solve the above-described problems and an objective of the disclosure is intended to provide a stabilizer bar assembly able to improve driving performance of a vehicle by separating two wheels of the vehicle according to road surface conditions.

In an embodiment, a stabilizer bar assembly according to an aspect of the disclosure includes: a movable member including one or more guide protrusions protruding outward; a housing including a movable member receptacle where the movable member is disposed and a drive member receptacle where a drive member which moves the movable member is disposed, the drive member receptacle being connected to the movable member receptacle; a first stabilizer bar connected to a first side of the housing to selectively rotate and allowing the movable member to be inserted thereinto; and a second stabilizer bar connected to a second side of the housing to rotate integrally with the housing.

The stabilizer bar assembly of the disclosure may further include a bearing configured to allow the first stabilizer bar and the housing to rotate independently.

The first stabilizer bar of the disclosure may be press-fitted into the inner ring of the bearing, and the outer ring of the bearing may be press-fitted into the inner diameter of the housing.

The movable member receptacle of the disclosure may include: a rigidity generator including one or more guide grooves configured to guide a movement path of the movable member and corresponding to the guide protrusions to restrain rotation of the guide protrusions; and a rigidity remover disposed between the rigidity generator and the drive member receptacle.

The movable member of the disclosure may be disposed in the rigidity generator or the rigidity remover.

The movable member of the disclosure may include the guide protrusions and a movable body having an outer diameter smaller than the inner diameter of the movable member receptacle.

The first stabilizer bar of the disclosure in the rigidity generator may have the movable member inserted thereinto, wherein the movable member which is inserted into the guide grooves to be rotation-constrained may allow the first stabilizer bar to rotate integrally with the housing, and the first stabilizer bar of the disclosure in the rigidity remover may be separated from the movable member and rotate independently of the housing.

The first stabilizer bar of the disclosure may include spline grooves engaging with the movable member to limit a maximum travel distance of the movable member.

The movable member of the disclosure may include spline protrusions on an inner surface to engage with the spline grooves.

The drive member of the disclosure may include: a motor configured such that the second stabilizer bar is press-fitted into the motor and including a rotating shaft; and a screw rotating together with the rotating shaft in linear motion thereof and moving the movable member from the drive member receptacle to the movable member receptacle.

The stabilizer bar assembly of the disclosure may further include a spring elastically deformable so that the movable member returns from the rigidity generator to the rigidity remover.

The drive member receptacle of the disclosure may have a diameter smaller than the diameter of the movable member receptacle, and an outer portion of the movable member corresponds to the diameter of the movable member receptacle.

The drive member of the disclosure may further include a shock absorber disposed between the movable member and the screw and absorbing impact or vibration caused by the spring.

The stabilizer bar assembly of the disclosure may further include a controller controlling the movable member to be disposed in either the rigidity generator or the rigidity remover.

The controller of the disclosure may determine a movement position of the movable member in response to a button control, wherein the controller controls the drive member to rotate in one direction when a target position of the movable member is the rigidity generator and to rotate in an opposite direction when the target position of the movable member is the rigidity remover.

The stabilizer bar assembly according to the disclosure may separate the stabilizer bars during off-road driving to ensure independent wheel movement, thereby improving ride comfort during off-road driving and on uneven roads.

On flat roads, the stabilizer bar assembly according to the disclosure may connect the stabilizer bar to secure torsional rigidity, thereby increasing the steering response and stability of the vehicle.

The stabilizer bar assembly according to the disclosure may have fewer components and a simpler structure, thereby reducing manufacturing and maintenance costs and the potential for malfunction.

The stabilizer bar assembly according to the disclosure may switch operation via electronic control, thereby achieving torsional rigidity simply and quickly.

The stabilizer bar assembly according to the disclosure may improve fuel efficiency by reducing energy loss and mechanical resistance caused by maintaining unnecessary torsional rigidity.

### BRIEF DESCRIPTION OF THE DRAWINGS

FIG. 1 is a perspective view illustrating a stabilizer bar assembly according to embodiments of the disclosure;

FIG. 2 is an exploded perspective view illustrating the stabilizer bar assembly according to embodiments of the disclosure.

FIG. 3 is a cross-sectional view illustrating the housing of the stabilizer bar assembly according to embodiments of the disclosure, taken along line II-II’ shown in FIG. 2;

FIG. 4 is a cross-sectional view illustrating positioning of the movable member in the rigidity generator in the stabilizer bar assembly according to embodiments of the disclosure;

FIG. 5 is a cross-sectional view illustrating the housing of the stabilizer bar assembly according to embodiments of the disclosure, taken along line III-III’ shown in FIG. 2;

FIG. 6 schematically illustrates positioning of the movable member in the rigidity remover in the stabilizer bar assembly according to embodiments of the disclosure

FIG. 7 schematically illustrates coupling between the first stabilizer bar and the movable member of the stabilizer bar assembly according to embodiments of the disclosure;

FIG. 8 schematically illustrates rotation of the first stabilizer bar and the movable member of the stabilizer bar assembly according to embodiments of the disclosure;

FIG. 9 schematically illustrates coupling between the second stabilizer bar and the housing of stabilizer bar assembly according to embodiments of the disclosure;

FIG. 10 schematically illustrates rotation of the second stabilizer bar and the housing of the stabilizer bar assembly according to embodiments of the disclosure;

FIG. 11 illustrates movement of the movable member to the rigidity generator in the stabilizer bar assembly according to embodiments of the disclosure;

FIG. 12 illustrates movement of the movable member to the rigidity remover in the stabilizer bar assembly according to embodiments of the disclosure; and

FIG. 13 schematically illustrates rigidity control of the stabilizer bar assembly according to embodiments of the disclosure.

### DETAILED DESCRIPTION

Hereinafter, embodiments of a stabilizer bar assembly according to the disclosure are described in conjunction with the attached drawings. However, the disclosure is not limited or restricted by the example embodiments.

Thicknesses of lines or sizes of elements shown in the drawings may be exaggerated for the sake of brevity. Terms used hereafter are defined in consideration of functions thereof in the disclosure, and may be varied according to the intention of a user or an operator, practices, or the like. Therefore, these terms should be defined on the basis of the contents of the entire specification.

In addition, herein, it will be understood that when an element is referred to as being “connected (or coupled)” to another element, not only can it be “directly connected (or coupled)” to the other element, but it can also be “indirectly connected (or coupled)” to the other element via an intervening element. It will also be understood that terms “comprise”, “include”, “have”, and any variations thereof used herein are intended to cover non-exclusive inclusions unless explicitly described to the contrary.

The objectives and effects of the disclosure may be understood from the description provided hereinafter but are not limited to the following description. In the description of the disclosure, a detailed description of known technology related to the disclosure will be omitted in a situation in which the subject matter of the disclosure may be rendered rather unclear thereby.

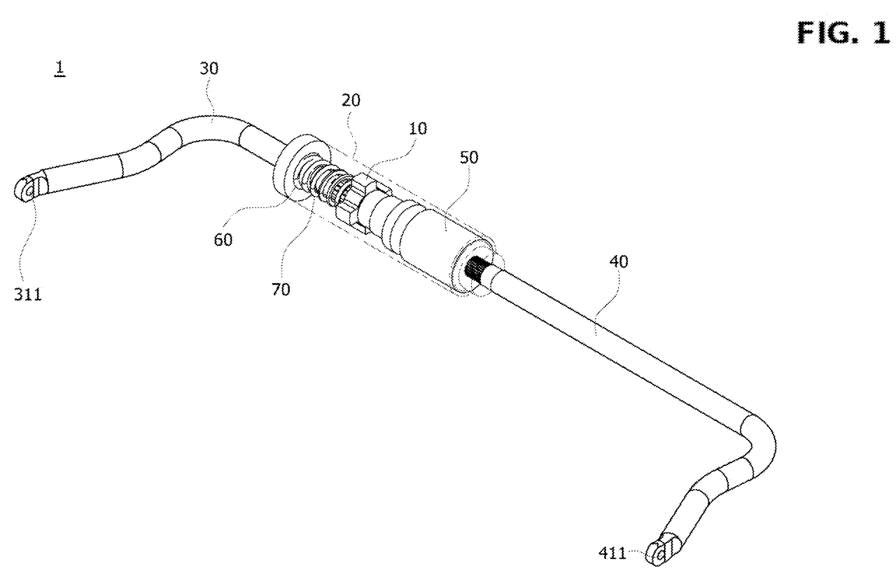

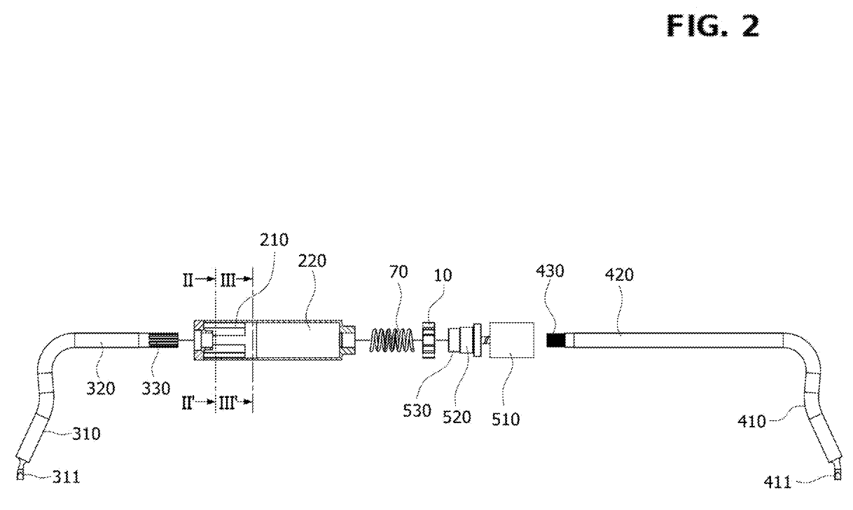

FIG. 1 is a perspective view illustrating a stabilizer bar assembly according to embodiments of the disclosure, and FIG. 2 is an exploded perspective view illustrating the stabilizer bar assembly according to embodiments of the disclosure.

Referring to FIGS. 1 and 2, a stabilizer bar assembly 1 according to embodiments of the disclosure includes a movable member 10, a housing 20, a first stabilizer bar 30, and a second stabilizer bar 40.

The movable member 10 may move in the housing 20. Depending on the position of the movable member 10, the rigidity of the first stabilizer bar 30 and the second stabilizer bar 40 may be generated or eliminated.

The movable member 10 according to an embodiment of the disclosure may include one or more guide protrusions 11 protruding outward and a movable body 12 having an outer diameter smaller than the inner diameter of the housing 20.

In this embodiment, four guide protrusions 11 are illustrated by way of example, but the number of guide protrusions 11 is not limited.

The guide protrusions 11 may be coupled to one or more guide grooves 212 described below to restrict the movement path of the movable member 10. That is, the guide grooves 212 may guide the movement path of the movable member 10. Because the guide protrusions 11 are coupled to the guide grooves 212, the movable member 10 may rotate integrally with the housing 20.

The movable member 10 may include a steel material. For example, the movable member 10 may be formed of carbon steel or alloy steel having excellent wear resistance.

The housing 20 may be located between the first stabilizer bar 30 and the second stabilizer bar 40. The first stabilizer bar 30 and the second stabilizer bar 40 may be inserted into and coupled to the housing 20 from opposite sides.

The housing 20 may accommodate the movable member 10 and a drive member 50. Specifically, the housing 20 may be provided with a movable member receptacle 210 where the movable member 10 is disposed and a drive member receptacle 220 where the drive member 50 is disposed. The housing 20 may be provided in a cylindrical shape, but the shape of the housing 20 is not limited.

The movable member receptacle 210 may accommodate the movable member 10. The movable member 10 may be moved in the movable member receptacle 210.

The drive member receptacle 220 may be connected to the movable member receptacle 210 and move the drive member 50 which moves the movable member 10. The drive member 50 may apply pressure toward the movable member 10 located in the movable member receptacle 210 to change the position of the movable member 10.

The drive member 50 may move the movable member 10 to a rigidity generator 210a or a rigidity remover 210b described later.

The drive member 50 may include a motor 510 and a screw 520.

The motor 510 may be a rotary motor. For example, the motor 510 may be a stepper motor, a DC motor, or a servo motor.

The motor 510 may be provided with a rotating shaft 511. The rotating shaft 511 may be connected to the motor 510 and rotate integrally with the motor 510 following the rotation of the motor 510.

The second stabilizer bar 40 may be press-fitted into the motor 510. That is, the second stabilizer bar 40 may be press-fit into the housing 20 and the motor 510.

The drive member 50 may include a screw 520 which rotates together with the rotating shaft 511 while moving in a straight line, and moves the movable member 10 from the drive member receptacle 220 to the movable member receptacle 210.

The screw 520 may convert the rotational motion of motor 510 into linear motion. In an embodiment, the screw 520 may be a ball screw or a lead screw. The ball screw may minimize friction and provide high efficiency, with ball bearings being inserted along a thread formed on the rotating shaft 511. The lead screw has a simple structure, is easy to maintain, and may be used in environments requiring relatively low-speed operation.

The screw 520 may convert rotational motion into linear motion to move the movable member 10 toward either the rigidity generator 210a or the rigidity remover 210b.

The movable member receptacle 210 and the drive member receptacle 220 may be partitioned by forming a stepped portion therebetween. The diameter of the drive member receptacle 220 may be smaller than the diameter of the movable member receptacle 210. The outer portion of the movable member 10 may correspond to the diameter of the movable member receptacle 210. Thus, the movable member 10 may be restricted from moving into the drive member receptacle 220 which is provided with a smaller diameter.

The first stabilizer bar 30 and the second stabilizer bar 40 are portions of the suspension system of the vehicle, and may reduce the rolling of the vehicle by adjusting torsional rigidity. Opposite ends of the first stabilizer bar 30 and the second stabilizer bar 40 may be connected to the suspension arms (not shown) of the left and right wheels of the vehicle via the stabilizer bar links (not shown).

The first stabilizer bar 30 and the second stabilizer bar 40 may reduce the rolling of the vehicle body when the vehicle turns. The first stabilizer bar 30 and the second stabilizer bar 40 transmit rotational force generated from a compressed wheel to the opposite wheel, thereby reducing any difference between the left and right wheels and preventing excessive tilting of the vehicle body. Without stabilizer bars, the vehicle may lean excessively to one side when cornering, potentially reducing tire traction. Therefore, the first stabilizer bar 30 and the second stabilizer bar 40 may maintain balanced lateral load distribution, thereby enhancing traction and enabling stable cornering.

The first stabilizer bar 30 and the second stabilizer bar 40 have little effect during straight-line driving but may act during cornering or sudden changes in the road surface. Consequently, the ride comfort and handling of the vehicle may be adjusted.

In this embodiment, a case in which the first stabilizer bar 30 is disposed to the left of the housing 20 and the second stabilizer bar 40 is disposed to the right of the housing 20 is described as an example, but the direction of combination is not limited.

The first stabilizer bar 30 may be connected to one side of the housing 20 to be selectively rotatable. The first stabilizer bar 30 may rotate together with the housing 20 or rotate independently of the housing 20 depending on the position of the movable member 10. Accordingly, the torsional rigidity of the stabilizer bar assembly 1 according to embodiments of the disclosure may be adjusted.

The movable member 10 may be inserted into the first stabilizer bar 30. The first stabilizer bar 30 may be coupled to the movable member 10. When the first stabilizer bar 30 is coupled to the movable member 10, the first stabilizer bar 30 may rotate integrally with the housing 20.

The stabilizer bar assembly 1 according to embodiments of the disclosure may further include a bearing 60 configured to allow the first stabilizer bar 30 and the housing 20 to rotate independently.

The first stabilizer bar 30 may be press-fitted into the inner ring of the bearing 60, and the outer ring of the bearing 60 may be press-fitted into the inner diameter of the housing 20. Thus, the first stabilizer bar 30 may rotate independently of the housing 20 via the bearing 60.

In an embodiment, the bearing 60 may be a spherical ball bearing or a roller bearing.

The first stabilizer bar 30 may include a coupling portion 310 having a through-hole 311, into which a motion shaft (not shown) transmitting the rolling motion of vehicle is inserted, and an extension 320 extending from the coupling portion 310 and disposed in the width direction of the vehicle.

The motion shaft may be a stabilizer bar link in an embodiment. The motion shaft may connect one end of the first stabilizer bar 30 to the suspension arm. The motion shaft may transmit force generated when the suspension moves to the first stabilizer bar 30, thereby generating torsional rigidity.

The motion shaft may be inserted into the through-hole 311 of the coupling portion 310. The coupling portion 310 may be formed in a bent shape. The through-hole 311 may be provided at one end of the coupling portion 310. Because the motion shaft is coupled to the through-hole 311, force from the first stabilizer bar 30 may be transmitted to the suspension arm.

The extension 320 may extend from the coupling portion 310. The extension 320 may bend and extend from the coupling portion 310. That is, the configuration formed by connecting the extension 320 and the coupling portion 310 may have an “L” shape.

The second stabilizer bar 40 may be connected to the opposite side of the housing 20 such that the second stabilizer bar 40 is rotatable integrally with the housing 20. Consequently, the second stabilizer bar 40 may always rotate integrally with the housing 20. Because the first stabilizer bar 30 is connected and rotates with the housing 20 in a selective manner, the first stabilizer bar 30 and the second stabilizer bar 40 may be connected selectively.

That is, depending on the positioning of the movable member 10, the first stabilizer bar 30 and the second stabilizer bar 40 may be connected or disconnected via the housing 20. When the first stabilizer bar 30 and the second stabilizer bar 40 are connected, the stabilizer bar assembly 1 may have rigidity. Conversely, when the first stabilizer bar 30 and the second stabilizer bar 40 are disconnected, the rigidity of the stabilizer bar assembly 1 may be removed.

The second stabilizer bar 40 may include a coupling portion 410 having a through-hole 411, into which a motion shaft (not shown) transmitting rolling motion of the vehicle is inserted, and an extension 420 extending from the coupling portion 410 and disposed in the width direction of the vehicle.

The motion shaft may be a stabilizer bar link in an embodiment. The motion shaft may connect one end of the second stabilizer bar 40 to the suspension arm. The motion shaft may transmit force generated when the suspension moves to the second stabilizer bar 40, thereby generating torsional rigidity.

The motion shaft may be inserted into the through-hole 411 of the coupling portion 410. The coupling portion 410 may be formed in a bent shape. The through-hole 411 may be positioned at one end of the coupling portion 410. Because the motion shaft is coupled to the through-hole 411, force from the second stabilizer bar 40 may be transmitted to the suspension arm.

The extension 420 may extend from the coupling portion 410. The extension 420 may bend and extend from the coupling portion 410. That is, the configuration formed by connecting the extension 420 and the coupling portion 410 may have an “L” shape.

The movable member receptacle 210 may include the rigidity generator 210a in which the movable member 10 is positioned so that the rigidity of the stabilizer bar assembly 1 is generated and the rigidity remover 210b in which the movable member 10 is positioned so that the rigidity of the stabilizer bar assembly 1 is removed.

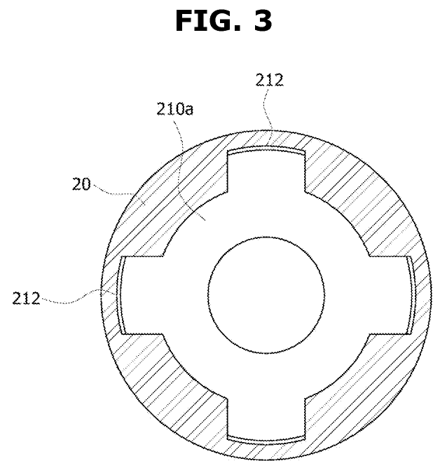

FIG. 3 is a cross-sectional view illustrating the housing of the stabilizer bar assembly according to embodiments of the disclosure, taken along line II-II’ shown in FIG. 2.

Referring to FIG. 3, the rigidity generator 210a may guide the path along which the movable member 10 moves, and may include the guide grooves 212 corresponding to the guide protrusions 11 to constrain the rotation of the guide protrusions 11.

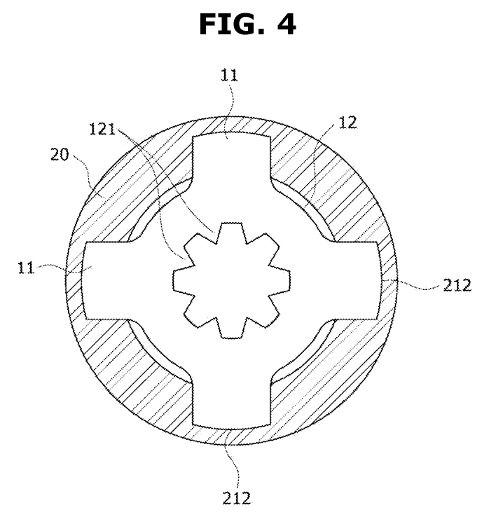

FIG. 4 is a cross-sectional view illustrating positioning of the movable member 10 in the rigidity generator 210a in the stabilizer bar assembly 1 according to embodiments of the disclosure.

Referring to FIG. 4, the rigidity generator 210a is provided with the guide grooves 212, thereby allowing the guide protrusions 11 of the movable member 10 to slide.

The first stabilizer bar 30 in the rigidity generator 210a may have the movable member 10 inserted thereinto, wherein the movable member 10 which is inserted into the guide grooves 212 to be rotation-constrained may allow the first stabilizer bar 30 to rotate integrally with the housing 20. The first stabilizer bar 30 may be inserted up to the rigidity generator 210a, such that the movable member 10 may be inserted into and coupled to the first stabilizer bar 30 when the movable member 10 moves toward the rigidity generator 210a.

The engagement of the guide protrusions 11 and the guide grooves 212 allows the housing 20 and the movable member 10 to integrate. That is, the movable member 10 and the housing 20 may rotate together, and the first stabilizer bar 30, into which the movable member 10 is inserted, may generate torsional rigidity due to the restricted rotation of the housing 20.

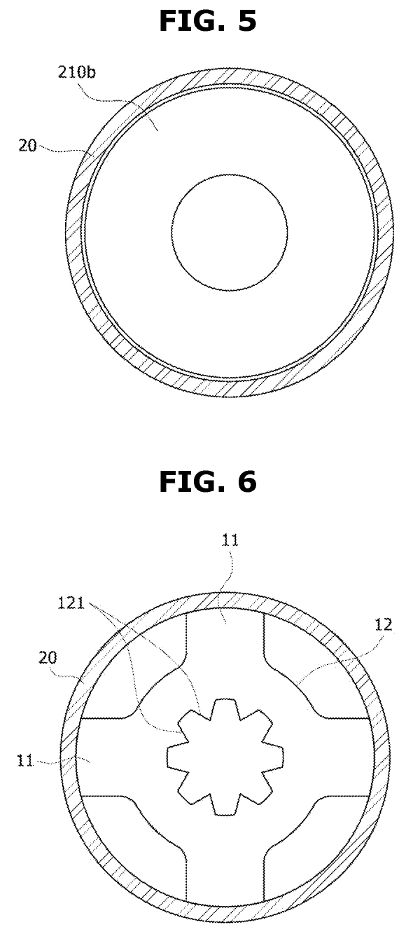

FIG. 5 is a cross-sectional view illustrating the housing of the stabilizer bar assembly according to embodiments of the disclosure, taken along line III-III’ shown in FIG. 2.

Referring to FIG. 5, the rigidity remover 210b may be disposed between the rigidity generator 210a and the drive member receptacle 220.

FIG. 6 schematically illustrates positioning of the movable member in the rigidity remover in the stabilizer bar assembly according to embodiments of the disclosure.

Referring to FIG. 6, the rigidity remover 210b does not have the guide grooves 212, thereby enabling free rotation of the movable member 10. That is, because the movable member 10 and the housing 20 are not coupled in the rigidity remover 210b, no rigidity is generated in the first stabilizer bar 30 or the second stabilizer bar 40.

The first stabilizer bar 30 in the rigidity remover 210b may be separated from the movable member 10 and rotate independently of the housing 20. Because the first stabilizer bar 30 does not extend to the rigidity remover 210b, when the movable member 10 moves toward the rigidity remover 210b, the first stabilizer bar 30 and the movable member 10 may be separated from each other. The first stabilizer bar 30 may rotate independently of the rotation of the housing 20.

The movable member 10 may move in the movable member receptacle 210. Specifically, the movable member 10 may be disposed either in the rigidity generator 210a or the rigidity remover 210b.

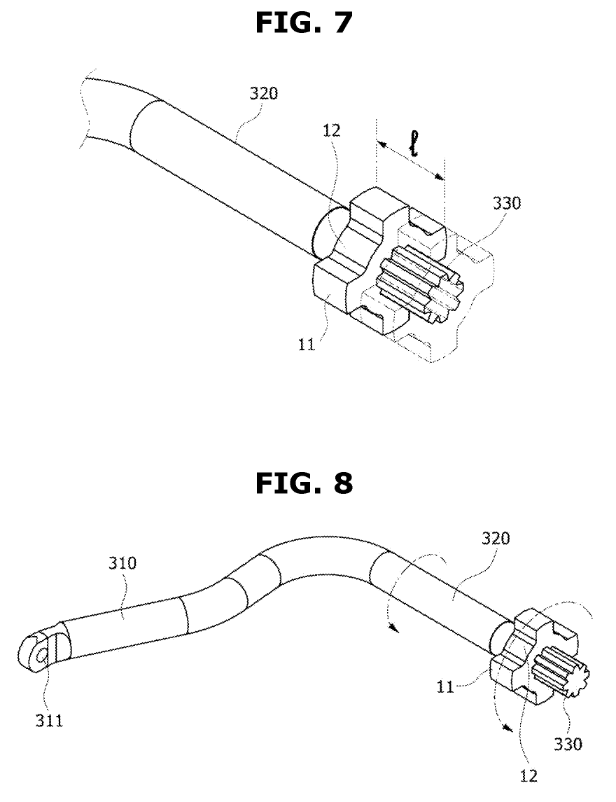

FIG. 7 schematically illustrates coupling between the first stabilizer bar and the movable member of the stabilizer bar assembly according to embodiments of the disclosure.

The first stabilizer bar 30 may include spline grooves 330 configured to engage with the movable member 10 to limit the maximum travel distance of the movable member 10. Specifically, the spline grooves 330 may be formed on one end of the extension 320 of the first stabilizer bar 30.

The movable member 10 may have spline protrusions 121 on the inner surface to engage with the spline grooves 330. As the movable member 10 moves, the spline protrusions 121 may engage with the spline grooves 330 of the first stabilizer bar 30.

Lubricant may be applied between the spline grooves 330 and the spline protrusions 121. An example of the lubricant may be grease. Applying grease to the entire circumference of the spline grooves 330 may reduce friction that occurs between the spline grooves 330 and the spline protrusions 121.

The range of movement of the movable member 10 may be limited by the length of the spline grooves 330. Because the spline protrusions 121 are provided on the movable member 10, the movable member 10 may not move toward the first stabilizer bar 30 where the spline grooves 330 are not formed. Consequently, the operating range of the drive member 50 which presses the movable member 10 may be reduced.

FIG. 8 schematically illustrates rotation of the first stabilizer bar and the movable member of the stabilizer bar assembly according to embodiments of the disclosure.

Referring to FIG. 8, when the first stabilizer bar 30 rotates, the movable member 10 may rotate together with the first stabilizer bar 30. The first stabilizer bar 30 and the movable member 10 may be engaged and rotate together. At this time, the guide protrusions 11 of the movable member 10 are fixed to the guide grooves 212 of the housing 20, and thus, the housing 20 may also rotate together.

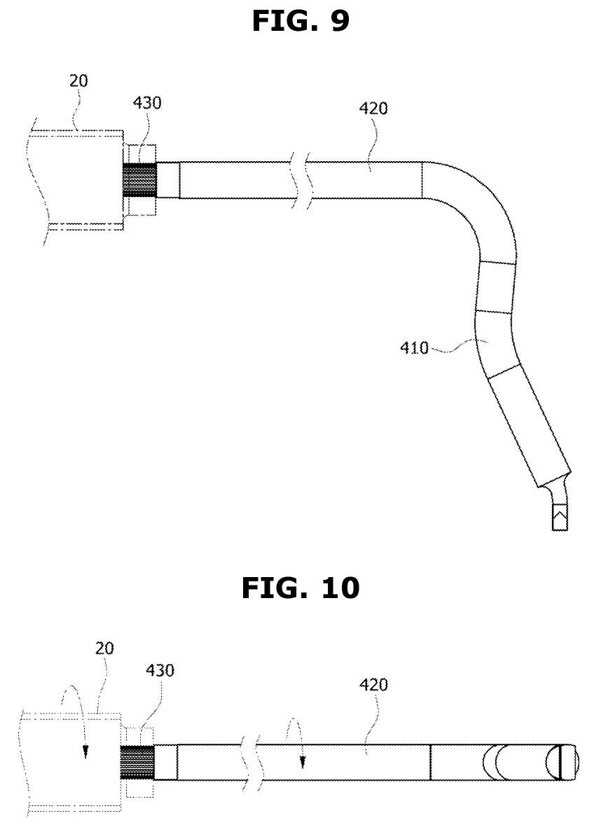

FIG. 9 schematically illustrates coupling between the second stabilizer bar and the housing of stabilizer bar assembly according to embodiments of the disclosure.

Referring to FIG. 9, the second stabilizer bar 40 may be press-fitted into the housing 20. Interference fit protrusions 430 may be provided on one end of the extension 420 of the second stabilizer bar 40 to increase coupling force to the housing 20. Consequently, the second stabilizer bar 40 may have increased friction when coupled to the housing 20.

The second stabilizer bar 40 may be fixed to the housing 20. That is, the second stabilizer bar 40 may rotate integrally with the housing 20.

FIG. 10 schematically illustrates rotation of the second stabilizer bar and the housing of the stabilizer bar assembly according to embodiments of the disclosure.

Referring to FIG. 10, the housing 20 may rotate together with the second stabilizer bar 40 in the direction of rotation of the second stabilizer bar 40.

When the first stabilizer bar 30, the movable member 10, and the housing 20 rotate together as shown in FIG. 8 or the second stabilizer bar 40 and the housing 20 rotate together as shown in FIG. 10, torsional rigidity may occur in the first stabilizer bar 30 and the second stabilizer bar 40. Consequently, torsional rigidity may occur in the stabilizer bar assembly 1.

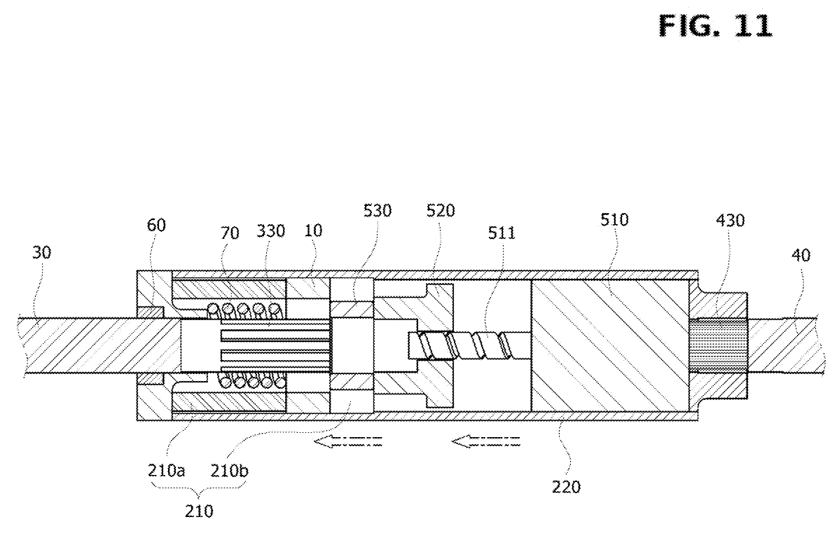

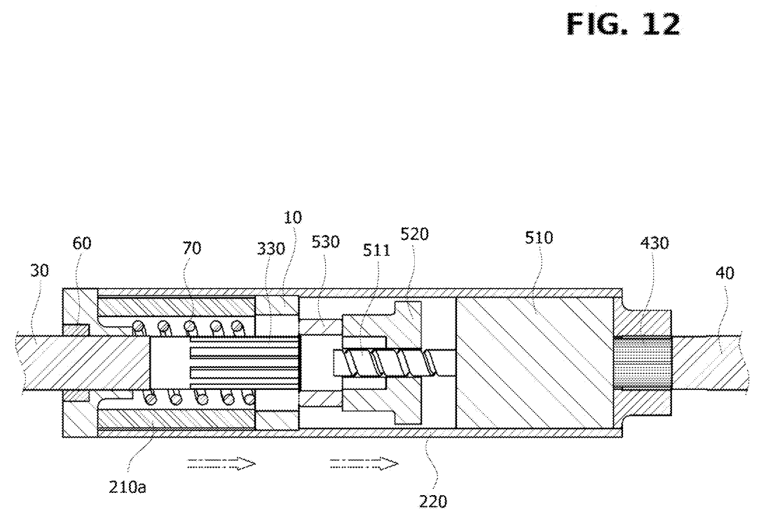

FIG. 11 illustrates movement of the movable member to the rigidity generator in the stabilizer bar assembly according to embodiments of the disclosure, and FIG. 12 illustrates movement of the movable member to the rigidity remover in the stabilizer bar assembly according to embodiments of the disclosure.

Referring to FIGS. 11 and 12, the stabilizer bar assembly 1 according to embodiments of the disclosure may further include a spring 70.

The spring 70 may be provided to be elastically deformable so that the movable member 10 returns from the rigidity generator 210a to the rigidity remover 210b. The spring 70 may be provided in the form of a compression spring or a torsion spring in an embodiment.

The spring 70 may be disposed between the movable member 10 and the bearing 60. The spring 70 may be elastically deformed so that the movable member 10 may return to the original position, the rigidity remover 210b. That is, the spring 70 may provide force that returns the movable member 10 from the rigidity generator 210a to the rigidity remover 210b.

As shown in FIG. 11, when the drive member 50 moves the movable member 10 toward the rigidity generator 210a, the drive member 50 may rotate in one direction to press against the movable member 10. As the movable member 10 moves to the left, the spring 70 may be compressed.

As shown in FIG. 12, when the movable member 10 must move back toward the rigidity remover 210b, the drive member 50 may rotate in the opposite direction. As the screw 520 connected to the motor 510 moves to the right, the force applied by the drive member 50 to press the movable member 10 is removed, and the spring 70 may be stretched by the elastic force. At this time, the movable member 10 may move to the right due to the elastic force of the spring 70. As the movable member 10 moves toward the rigidity remover 210b, the movable member 10 may rotate freely in the housing 20. The rotation of the first stabilizer bar 30 and the rotation of the second stabilizer bar 40 may occur independently, thereby eliminating rigidity. Consequently, the stabilizer bar assembly 1 according to the disclosure may control rigidity according to the dynamic characteristics of the vehicle.

The drive member receptacle 220 may have a diameter smaller than that of the movable member receptacle 210. The stepped portion may be formed between the drive member receptacle 220 and the movable member receptacle 210.

The outer portion of the movable member 10 may correspond to the diameter of the movable member receptacle 210. That is, each of the movable member 10 and the movable member receptacle 210 may have a diameter larger than that of the drive member receptacle 220.

Thus, even in the case in which the movable member 10 moves toward the drive member receptacle 220 due to the elastic force of the spring 70, the movement of the movable member 10 may be restricted by the stepped portion formed between the drive member receptacle 220 and the movable member receptacle 210. That is, the movable member 10 may be prevented from moving toward the drive member receptacle 220.

The drive member 50 may further include a shock absorber 530 disposed between the movable member 10 and the screw 520 and configured to absorb impact or vibration caused by the spring 70.

The shock absorber 530 may be disposed between the movable member 10 and the screw 520 to reduce shocks that may occur during operation. Specifically, the shock absorber 530 may absorb shocks and vibrations caused by the spring 70, thereby ensuring the operational stability of the movable member 10.

The shock absorber 530 may have a cylindrical or pad shape. The shock absorber 530 may include high-elasticity rubber, polyurethane, or silicone.

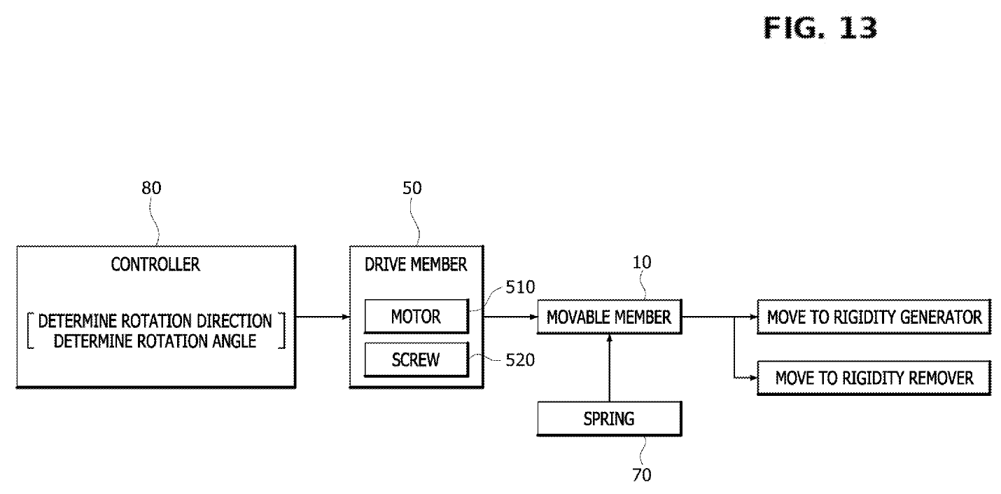

FIG. 13 schematically illustrates rigidity control of the stabilizer bar assembly according to embodiments of the disclosure.

Referring to FIG. 13, the stabilizer bar assembly 1 according to embodiments of the disclosure may further include a controller 80 to control the movement of the movable member 10.

The controller 80 may control the movable member 10 to be positioned in either the rigidity generator 210a or the rigidity remover 210b. For example, when the controller 80 intends to control the movable member 10 to be positioned in the rigidity generator 210a, the controller 80 may set the motor 510 of the drive member 50 to rotate clockwise. When the controller 80 intends to control the movable member 10 to be positioned in the rigidity remover 210b, the controller 80 may set the motor 510 of the drive member 50 to rotate counterclockwise.

The controller 80 may be controlled by the button control of an occupant. The controller 80 may determine the movement position of the movable member 10 in response to the button control.

The controller 80 may control the drive member 50 to rotate in one direction when the target position of the movable member 10 is the rigidity generator 210a and to rotate in the opposite direction when the target position of the movable member 10 is the rigidity remover 210b. The controller 80 may determine the rotation direction and the rotation angle of the motor 510 and adjust the rotation direction and the rotation angle to move the movable member 10 to an accurate position.

For example, when the target position of the movable member 10 is set to the rigidity generator 210a via the button control, the controller 80 may rotate the motor 510 clockwise. When the motor 510 rotates clockwise, the screw 520 connected to the motor 510 may rotate and convert motion into linear motion. The shock absorber 530 and the movable member 10 adjacent to the screw 520 may move toward the rigidity generator 210a. As the movable member 10 is inserted along the guide grooves 212 provided on the rigidity generator 210a, the housing 20, the first stabilizer bar 30, and the movable member 10 may be connected integrally and rotate together. Because the housing 20 is coupled to the second stabilizer bar 40 to rotate integrally with the second stabilizer bar 40, the first stabilizer bar 30 and the second stabilizer bar 40 are connected to generate torsional rigidity.

Conversely, when the target position of the movable member 10 is set to the rigidity remover 210b via the button control, the controller 80 may rotate the motor 510 counterclockwise. When the motor 510 rotates counterclockwise, the screw 520 connected to the motor 510 may rotate and convert motion into linear motion. The shock absorber 530 adjacent to the screw 520 may move in the opposite direction of the rigidity generator 210a. The movable member 10 may move toward the motor 510 due to the elastic force of the spring 70. As the movable member 10 disengages from the guide grooves 212 and moves toward the rigidity remover 210b, the housing 20, the first stabilizer bar 30, and the movable member 10 may be separated, and the first stabilizer bar 30 and the housing 20 may rotate independently. Because the housing 20 is linked only to the rotation of the second stabilizer bar 40, the first stabilizer bar 30 and the second stabilizer bar 40 are separated from each other, thereby eliminating torsional rigidity.

When the movable member 10 has not reached the target position, the rotation angle of the motor 510 may be finely adjusted to precisely adjust the movable member 10 to the optimal position. When the movable member 10 has moved to the target position precisely, the controller 80 may instruct the motor 510 to stop operating and maintain the system in a standby state.

Consequently, the rigidity of the stabilizer bar may be adjusted at any moment desired by the occupant. Because the target position is limited to the rigidity generator 210a or the rigidity remover 210b, the operation may be performed quickly and accurately without unnecessary intermediate positions.

The stabilizer bar assembly 1 according to embodiments of the disclosure may further include a sensor. For example, the sensor may be a position sensor. The sensor may transmit sensor values in real time to the controller 80 to control the position of the motor 510 by detecting the position of the movable member 10. In another embodiment, the sensor may be a Hall sensor. The sensor may detect whether gears are engaged using a magnetic field.

The rigidity remover 210b may be used when the vehicle is traveling off-road. In off-road driving, the wheels must move independently to improve ride comfort and driving performance. When the first stabilizer bar 30 and the second stabilizer bar 40 are separated, the flexibility of the suspension may increase, thereby allowing the wheels to move more freely even on rough terrain. Therefore, in the rigidity remover 210b, the occupant may control the button so that the housing 20 is connected only to the second stabilizer bar 40 and rotates independently of the first stabilizer bar 30.

The rigidity generator 210a may be used when the vehicle is traveling on a flatland or a road. During high-speed driving and cornering, the rigidity generator may reduce the rolling of the vehicle body to ensure driving stability. The rigidity generator may be set such that the movable member 10 is fully engaged with the first gear and the second gear, thereby ensuring that the first stabilizer bar 30 and the second stabilizer bar 40 have rigidity. However, when the phase of the guide grooves 212 of the housing 20 is not similar to the phase of the guide grooves 212 of the movable member 10, engagement may not be possible in any state.

When a vehicle is traveling off-road, the wheels may lift or experience impacts from the road surface, which makes it highly possible that the opposite ends of the first and second stabilizer bars 30 and 40 move at different angles. Consequently, the phase of the guide grooves 212 and the guide protrusions 11 may change irregularly, thereby potentially causing position misalignment of the guide grooves 212 and the guide protrusions 11. That is, in off-road conditions, it may be impossible to move toward the rigidity generator 210a of the movable member 10.

Conversely, when the vehicle is traveling on a flatland or a road, the phase between the guide grooves 212 and the guide protrusions 11 may be constant, thereby allowing the guide protrusions 11 to be inserted into the guide grooves 212. That is, when the vehicle is not traveling on a flatland or a road, movement to the rigidity generator 210a of the movable member 10 may be impossible, thereby making driving in rigidity generation mode impossible. In this case, the system automatically waits until the phase alignment between the guide grooves 212 and the guide protrusions 11 is achieved. Once the vehicle is traveling on a flat surface, the connection between the guide grooves 212 and the guide protrusions 11 may be attempted again.

Accordingly, the stabilizer bar assembly according to embodiments of the disclosure may achieve the following effects.

The stabilizer bar assembly according to the disclosure may separate the stabilizer bars during off-road driving to ensure independent wheel movement, thereby improving ride comfort during off-road driving and on uneven roads. On flat roads, the stabilizer bar assembly may connect the stabilizer bar to secure torsional rigidity, thereby increasing the steering response and stability of the vehicle. Accordingly, appropriate torsional rigidity may be achieved according to the driving environment. Because the stabilizer bar assembly has fewer components and a simpler structure, manufacturing and maintenance costs and the potential for malfunction may be reduced.

Although the foregoing embodiments have been provided to illustrate the disclosure in conjunction with the accompanying drawings, it will be apparent to a person of ordinary skill in the art that the embodiments are given by way of illustration only, and that various modifications and equivalent embodiments may be made without departing from the spirit and scope of the disclosure. Therefore, the true scope of the technical protection of the disclosure should be determined by the following claims.

What is claimed is:

1. A stabilizer bar assembly comprising:
a movable member comprising one or more guide protrusions protruding outward;
a housing comprising:
a movable member receptacle where the movable member is disposed; and
a drive member receptacle where a drive member which moves the movable member is disposed,
wherein the drive member receptacle is connected to the movable member receptacle;
a first stabilizer bar connected to a first side of the housing to selectively rotate and allowing the movable member to be inserted thereinto; and
a second stabilizer bar connected to a second side of the housing to rotate integrally with the housing.

2. The stabilizer bar assembly of claim 1, wherein the movable member receptacle comprises:
a rigidity generator comprising one or more guide grooves guiding a movement path of the movable member and corresponding to the one or more guide protrusions to restrain rotation of the one or more guide protrusions; and
a rigidity remover disposed between the rigidity generator and the drive member receptacle,
wherein the movable member is disposed in the rigidity generator or the rigidity remover.

3. The stabilizer bar assembly of claim 2,
wherein the first stabilizer bar in the rigidity generator has the movable member inserted thereinto, wherein the movable member which is inserted into the one or more guide grooves to be rotation-constrained allows the first stabilizer bar to rotate integrally with the housing, and
wherein the first stabilizer bar in the rigidity remover is separated from the movable member and rotates independently of the housing.

4. The stabilizer bar assembly of claim 3, wherein the first stabilizer bar comprises spline grooves engaging with the movable member to limit a maximum travel distance of the movable member.

5. The stabilizer bar assembly of claim 4, wherein the drive member comprises:
a motor configured such that the second stabilizer bar is press-fitted into the motor and comprising a rotating shaft; and
a screw rotating together with the rotating shaft in linear motion thereof and moving the movable member from the drive member receptacle to the movable member receptacle.

6. The stabilizer bar assembly of claim 5, further comprising a spring elastically deformable so that the movable member returns from the rigidity generator to the rigidity remover.

7. The stabilizer bar assembly of claim 6,
wherein the drive member receptacle has a diameter smaller than a diameter of the movable member receptacle, and
wherein an outer portion of the movable member corresponds to the diameter of the movable member receptacle.

8. The stabilizer bar assembly of claim 7, wherein the drive member further comprises a shock absorber disposed between the movable member and the screw and absorbing impact or vibration caused by the spring.

9. The stabilizer bar assembly of claim 2, further comprising a controller controlling the movable member to be disposed in either the rigidity generator or the rigidity remover.

10. The stabilizer bar assembly of claim 9,
wherein the controller determines a movement position of the movable member in response to a button control, and
wherein the controller controls the drive member to rotate in a direction based on that a target position of the movable member is the rigidity generator and to rotate in an opposite direction based on that the target position of the movable member is the rigidity remover.
